(19) United States
(12) Patent Application Publication
(10) Pub. No.: US 2019/0191135 A1
(43) Pub. Date: Jun. 20, 2019

(54) METHOD FOR MANAGING IMAGE PROJECTION OF ELECTRONIC DEVICE, ELECTRONIC DEVICE AND PROJECTOR

(71) Applicant: Lenovo (Beijing) Co., Ltd., Beijing (CN)

(72) Inventors: Jian DENG, Beijing (CN); Fangzhen PENG, Beijing (CN); Xingdong SHENG, Beijing (CN)

(21) Appl. No.: 16/227,460

(22) Filed: Dec. 20, 2018

(30) Foreign Application Priority Data
Dec. 20, 2017 (CN) 201711388675.8

(51) Int. Cl. H04N 9/31

(52) U.S. Cl. CPC H04N 9/3188

(57) ABSTRACT

A method for managing projection of an electronic device includes obtaining ambient parameters of a projection screen, and adjusting a size or brightness level of a projection image projected on the projection screen by the electronic device, based on the ambient parameters. The present disclosure also provides an electronic device and a projector.

### CROSS-REFERENCE TO RELATED APPLICATION

This application claims the priority of Chinese Patent Application No. 201711388675.8, filed on Dec. 20, 2017, the entire content of which is incorporated herein by reference.

### TECHNICAL FIELD

The present disclosure relates to a method for managing image projection of an electronic device, the electronic device, and a projector.

### BACKGROUND

With the development of science and technology, projection technology is widely applied in various fields to bring convenience to people's lives. Often, when a projector is used, the position of the projector needs to be manually adjusted so that a resulting projection area can have a suitable size.

### SUMMARY

In accordance with the disclosure, one aspect of the present disclosure provides a method for managing projection of an electronic device. The method includes obtaining ambient parameters of a projection screen and adjusting a size or a brightness level of a projection image projected on the projection screen by the electronic device, based on the ambient parameters.

In accordance with the disclosure, another aspect of the present disclosure provides an electronic device including a processor and a memory. The memory can store computer readable instructions. When the instructions are executed by the processor, the computer readable instructions can perform a method for managing projection of an electronic device. The method includes obtaining ambient parameters of a projection screen and adjusting a size or a brightness level of a projection image projected on the projection screen by the electronic device, based on the ambient parameters.

In accordance with the disclosure, further another aspect of the present disclosure provides a projector including an acquisition module and an adjustment module. The acquisition module can obtain ambient parameters of a projection screen. The adjustment module can adjust at least of a size or a brightness level of a projection image projected on the projection screen based on the ambient parameters.

### DESCRIPTION OF THE DRAWINGS

To clearly understand the present disclosure and advantages thereof, the present disclosure is described below with reference to the accompany drawings, in which:

FIG. 1 illustrates an application scenario of a method for managing projection of an electronic device according to an embodiment of the present disclosure;

FIG. 2 illustrates a flowchart of a method for managing projection of an electronic device according to an embodiment of the present disclosure;

FIG. 3A illustrates a flowchart of a method for managing projection of an electronic device according to another embodiment of the present disclosure;

FIG. 3B illustrates a flowchart of a method for managing projection of an electronic device according to another embodiment of the present disclosure;

FIG. 3C illustrates a flowchart of a method for managing projection of an electronic device according to another embodiment of the present disclosure;

FIG. 3D illustrates a flowchart of a method for managing projection of an electronic device according to another embodiment of the present disclosure;

FIG. 4 illustrates a flowchart of a method for managing projection of an electronic device according to another embodiment of the present disclosure;

FIG. 5 illustrates a block diagram of a projector according to an embodiment of the present disclosure;

FIG. 6 illustrates a block diagram of an adjustment module according to an embodiment of the present disclosure;

FIG. 7 illustrates a block diagram of a projector according to another embodiment of the present disclosure; and

FIG. 8 illustrates a block diagram of an electronic device applying a method for managing projection of an electronic device according to an embodiment of the present disclosure.

### DETAILED DESCRIPTION

Below describe embodiments of the present disclosure with reference to the accompanying drawings. It should be understood, however, that these descriptions are merely illustrative and are not intended to limit the scope of the present disclosure. In addition, in the following description, descriptions of well-known structures and techniques are omitted so as not to obscure the concept of the present disclosure.

Terms used herein are only for describing embodiments only but not intended to limit the present disclosure. The terms “including”, “comprising”, and the like, as used herein, indicate the presence of stated features, steps, operations, and/or components, but do not exclude the presence or addition of one or more other features, steps, operations, or components.

Unless otherwise defined, all the technical and scientific terms used herein have the same or similar meanings as generally understood by those skilled in the art. It should be noted that terms used herein should be interpreted as having meanings that are consistent with the context of the present specification and should not be interpreted in an idealized or overly rigid manner.

In terms of a statement similar to “at least one of A, B, and C, etc.,” it should be generally interpreted in the light of the ordinary understanding of the expression by those skilled in the art. For example, “a system including at least one of A, B, and C” shall include, but is not limited to, a system including A alone, a system including B alone, a system including C alone, a system including A and B, a system including A and C, a system including B and C, and/or a system including A, B, and C, etc. In terms of a statement similar to “at least one of A, B or C, etc.”, it should generally be interpreted in the light of the ordinary understanding of the expression by those skilled in the art. For example, “a system including at least one of A, B or C” shall include, but is not limited to, a system including A alone, a system including B alone, a system including C alone, a system including A and B, a system including A and C, a system including B and C, and/or a system including A, B, and C, etc. It should also be understood by those skilled in the art that all transitional words and/or phrases representing two or more alternative items, whether in the description, the claims or the drawings, should be understood as including one of these alternative items, or including any one of or all these alternative items. For example, the phrase “A or B” should be interpreted to include possibilities of including “A” or “B”, or including “A” and “B”.

Some block diagrams and/or flowcharts are shown in the drawings. It should be understood that some blocks and/or flows or combinations thereof in the block diagrams and/or the flowcharts can be implemented by computer program instructions. These computer program instructions may be provided to a processor of a general-purpose computer, a special-purpose computer, or other programmable-data processing device such that, when executed by the processor, these instructions can generate a device that can implement functions/operations illustrated in these block diagrams and/or flowcharts.

Thus, the techniques of the present disclosure may be implemented in the form of hardware and/or software (including firmware, microcode, etc.). In addition, the techniques of the present disclosure may be in a form of a computer program product on a computer-readable medium that stores instructions. The computer program product can be used by or in connection with an instruction execution system. In the context of the present disclosure, a computer-readable medium may be any medium that can contain, store, communicate, propagate, or transport the instructions. For example, the computer-readable medium may include, but is not limited to, an electronic, magnetic, optical, electromagnetic, infrared or semiconductor system, apparatus, device, or propagation medium. Optionally, examples of the computer-readable medium include: a magnetic storage device such as a magnetic tape or a hard disk (HDD); an optical storage device such as a compact disk read-only memory (CD-ROM); a memory such as a random-access memory (RAM) or a flash memory; and/or a cable/wireless communication link.

Embodiments of the present disclosure provide a method and a system for managing projection of an electronic device. Using the method, a size and/or brightness level of a projection image projected on the projection screen by the electronic device can be automatically adjusted according to a current ambient parameter without manual input, thereby improving user experience.

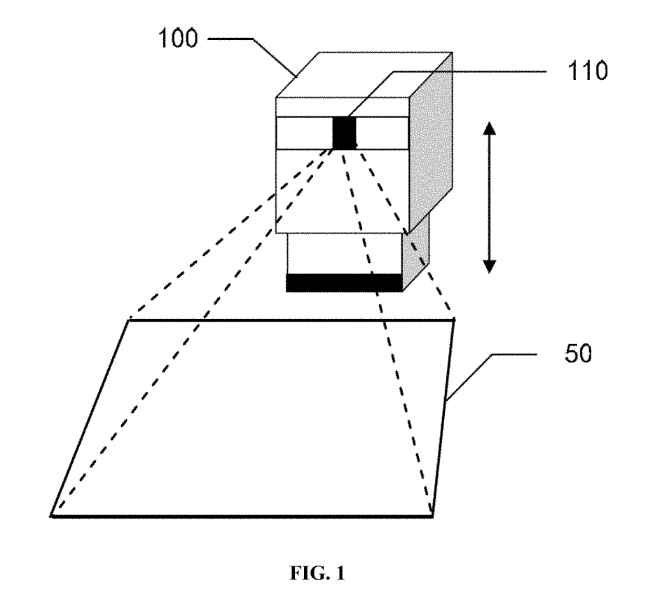

FIG. 1 illustrates an application scenario of a method for managing projection of an electronic device according to an embodiment of the present disclosure. It should be noted that FIG. 1 is merely an example of a scenario in which an embodiment of the present disclosure may be applied to help those skilled in the art to understand the technical content of the present disclosure, but it does not mean that embodiments of the present disclosure cannot be applied to other devices, system, environment or scenario.

As shown in FIG. 1, the electronic device 100 may include a projector 110. When a user uses the electronic device 100 to project on a projection screen, a display size and/or a display brightness level of the projection image 50 may need to be manually adjusted. For example, when the projection screen is small, the projection image 50 cannot be completely displayed on the projection screen. In this case, the user needs to manually adjust projection parameters of the electronic device 100 to make the projection image 50 smaller, or to move the electronic device 100 to reduce a distance between the electronic device 100 and the projection screen, thereby reducing a projection area of the projection image 50 to adapt to the area of the projection screen.

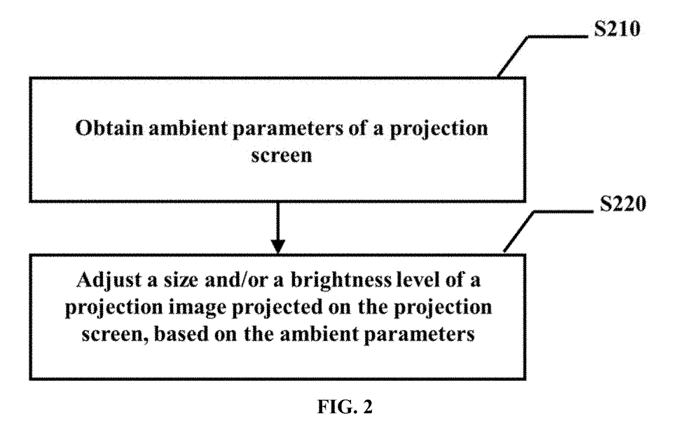

FIG. 2 illustrates a flowchart of a method for managing projection of an electronic device according to an embodiment of the present disclosure.

As shown in FIG. 2, the method may include operations S210 and S220.

In S210: The electronic device acquires ambient parameters of the projection screen that the electronic device projects onto.

According to embodiments of the present disclosure, the ambient parameters may include, for example, an ambient brightness level, a size of a projection screen, or the like. When there are one or more interactable objects on the projection screen, the ambient parameters may also include parameters of the one or more interactable objects, for example, whether a specific interactable object is included, a position of the one or more interactable objects on the projection image, or a quantity of the one or more interactable objects that appear at the same time. The above ambient parameters, for example, can be collected and recognized by a camera, or obtained through other sensors or electronic devices, which is not limited herein by embodiments of the present disclosure.

In S220: Based on the ambient parameters, the electronic device adjusts the size and/or brightness level of the projection image projected on the projection screen by the electronic device.

Using the method, based on current ambient parameters, the size and/or brightness level of the projection image projected on the project surface by the electronic device can be automatically adjusted, thereby improving the user experience.

According to embodiments of the present disclosure, the size and/or brightness level of the projection image projected on the projection screen by the electronic device, for example, can be adjusted by adjusting projection parameters of the projector of the electronic device, or by automatically moving a position of the projector.

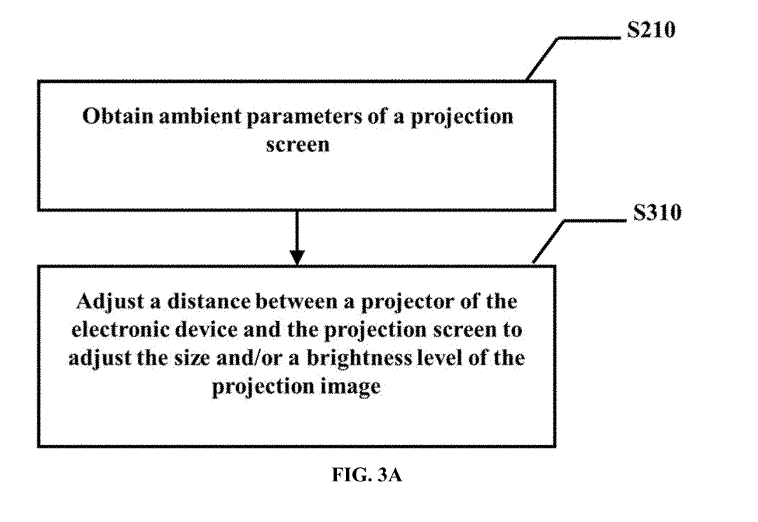

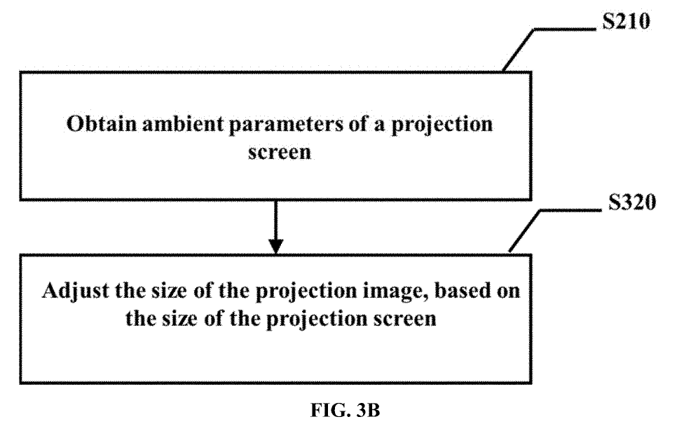

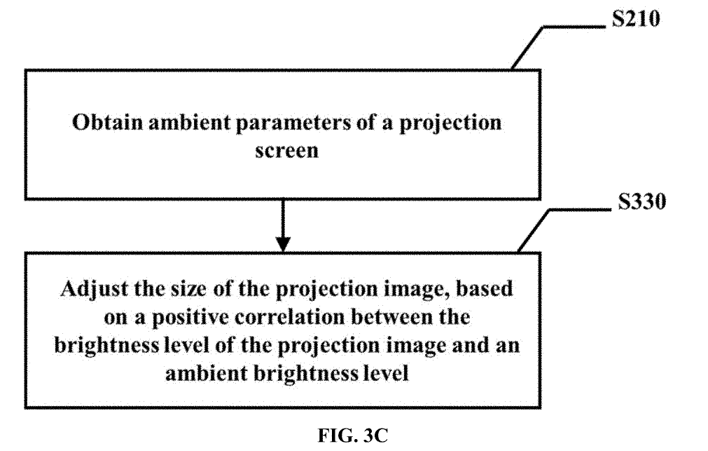

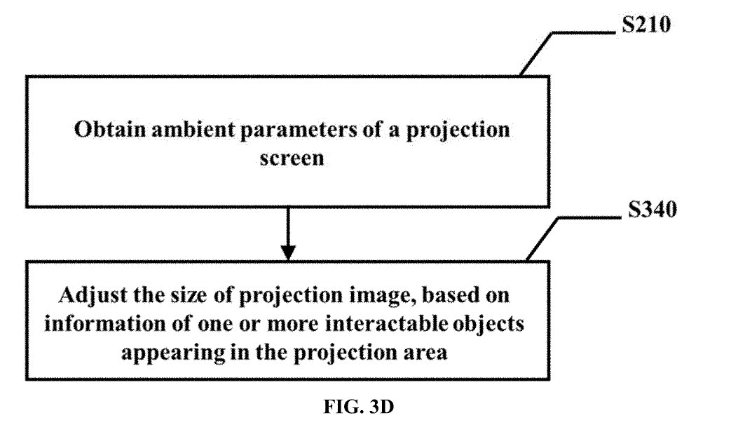

Some embodiments of the method are described below with reference to examples illustrated in FIG. 3A to FIG. 3D.

FIG. 3A illustrates a flowchart of a method for managing projection of an electronic device according to another embodiment of the present disclosure.

As shown in FIG. 3A, the method may include operations S210 and S310, where the operation S210 is similar to the foregoing embodiment and therefore is not elaborated herein again.

In S310: The electronic device adjusts the size and/or brightness level of the projection image projected on the projection screen by the electronic device is adjusted by adjusting a distance between the projector of the electronic device and the projection screen.

For example, an electronic device placed on a horizontal plane can be configured to project a projection image on the horizontal plane. Referring to FIG. 1, according to embodiments of the present disclosure, a portion where the projector 110 is located on the electronic device 100 may be able to move relative to a body of the electronic device 100 along an arrow shown in FIG. 1. The electronic device 100 may include a motor and a controller to control the movement of the portion where the projector 100 is located to adjust the distance between the projector 110 of the electronic device 100 and the projection screen, so as to realize an effect of adjusting the size and/or brightness level of the projection image projected on the projection screen by the electronic device 100.

According to embodiments of the present disclosure, the electronic device may further include an operation detector, which can collect optical information to realize interactive operation. When the distance between the projector of the electronic device and the projection screen is adjusted, the position of the operation detector may be kept unchanged.

For example, as shown in FIG. 1, the electronic device 100 may include an operation detector disposed on the electronic device 100 near a bottom of the electronic device 100 (for example, a black area near the bottom of the electronic device 100 as shown in FIG. 1). The operation detector can detect an operation of a user for the projection image on the projection screen, so as to realize an interactive operation. When the portion where the projector 110 is located on the electronic device is moved, because the operation detector is disposed on the body of the electronic device, the position of the operation detector can be kept unchanged and thereby does not affect the interaction process.

FIG. 3B illustrates a flowchart of a method for managing projection of an electronic device according to another embodiment of the present disclosure.

As shown in FIG. 3B, the method may include operations S210 and S320.

In S210: The electronic device acquires ambient parameters of the projection screen that the electronic device projects onto, where the ambient parameters may include the size of the projection screen.

In S320: The electronic device adjusts the size of the projection image projected on the projection screen by the electronic device based on the size of the projection screen.

For example, when the projection screen is smaller than the projection image, the projection image cannot be completely displayed on the projection screen, or when the projection screen is larger than the projection image, there is extra space available for displaying the projection image, which is a waste of the extra space. Using the method according to embodiments of the present disclosure, the size of the projection image projected on the projection screen by the electronic device can be adjusted to adapt to the area of the projection screen, based on the size of the projection screen

FIG. 3C illustrates a flowchart of a method for managing projection of an electronic device according to another embodiment of the present disclosure.

As shown in FIG. 3C, the method may include operations S210 and S330.

In S210: The electronic device acquires ambient parameters of the projection screen that the electronic device projects onto, where the ambient parameters may include the ambient brightness level. According to embodiments of the present disclosure, the ambient brightness level may be obtained by analyzing an image captured by the camera or may be obtained by a separately configured sensor.

In S330: The electronic device adjusts the brightness level of the projection image projected on the projection screen by the electronic device based on a positive correlation between the brightness level of the projection image projected on the projection screen by the electronic device and the ambient brightness level.

For example, when the ambient brightness level is relatively high, the projection image needs to have a higher brightness level so that the user can see clearly; when the ambient brightness level if relatively low, an excessively high brightness level may cause discomfort to the user. Therefore, adjusting the brightness level of the projection image based on the ambient brightness level can improve the user experience.

According to embodiments of the present disclosure, the brightness level of the projection image may be adjusted by adjusting parameters of the projector or may be adjusted by adjusting the distance between the projector and the projection screen. For example, reducing the distance may increase the brightness level of the projection image. Adjusting the distance between the projector and the projection screen can effectively reduce the energy consumption and overcome the current brightness level bottleneck.

FIG. 3D illustrates a flowchart of a method for managing projection of an electronic device according to another embodiment of the present disclosure.

As shown in FIG. 3D, the method may include operations S210 and S340.

In S210: The electronic device acquires ambient parameters of the projection screen that the electronic device projects onto, where the ambient parameters may include one or more interactable objects that appear in the projection area.

In S340: The electronic device adjusts the size and/or the brightness level of the projection image projected on the projection screen by the electronic device, based on information of the one or more interactable objects appearing in the projection area.

In a projection interaction process, using this method, the size of a suitable projection area can be determined according to the information of the one or more interactable objects.

According to embodiments of the present disclosure, the one or more interactable objects may include at least one of the following: an operating device, through which the user may interact with the electronic device, or a device-interactive tool, where the electronic device can perform interactive operation by recognizing an image of the device-interactive tool.

According to embodiments of the present disclosure, the information of the one or more interactable objects may include quantity of the operating device, a size and/or quantity of the device-interactive tool, a specific interactable object, and movement information of the interactable object, etc.

In one example, when there are at least two operating bodies or device-interactive tools, or the device-interactive tool has a relatively large size, the projection image may be enlarged to facilitate the operation and reduce maloperation. In another example, when a specific interactable object or movement information of the interactable object satisfies a preset condition, the size and/or brightness level of the projected image may be adjusted according to the preset condition.

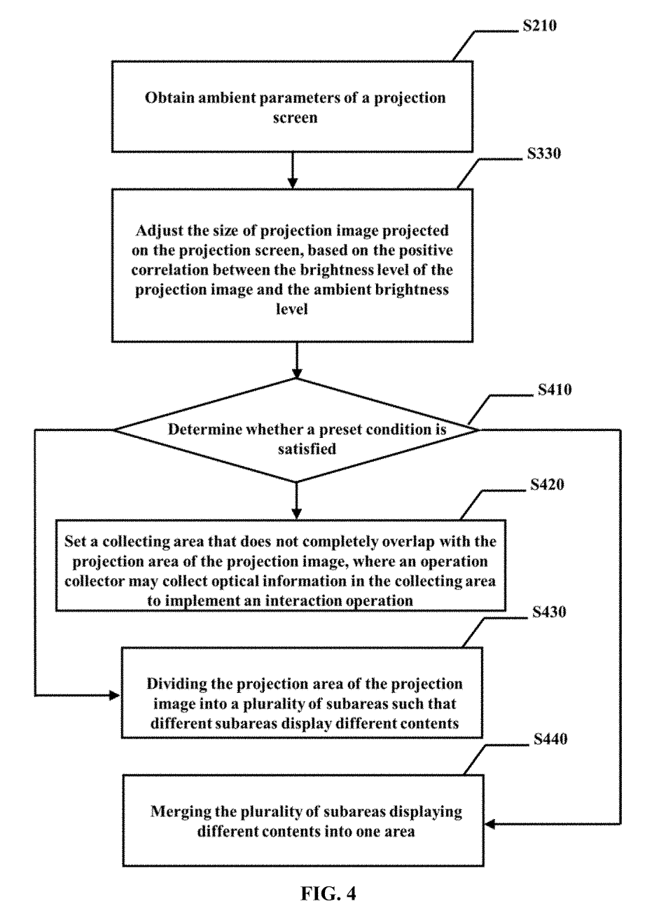

FIG. 4 illustrates a flowchart of a method for managing projection of an electronic device according to another embodiment of the present disclosure.

As shown in FIG. 4, the method may include operations S210, S330, S410 and at least one of S420, S430 or S440. The operations S210 and S330 are similar to the foregoing embodiments and therefore are not repeated herein.

In S410: The method according to embodiments of the present disclosure may trigger various operations, for example, at least one of operations S420, S430, or S440 by, for example, determining whether a certain trigger condition is satisfied.

In S420: The electronic device sets a collecting area that does not completely overlap with the projection area of the projection image, where an operation collector may collect optical information in the collecting area to implement an interaction operation.

In S430: The electronic device divides the projection area of the projection image into a plurality of subareas such that different subareas display different contents. For example, the projection area of the projection image may be divided into one main projection area and at least one sub-projection area, and different contents may be displayed in different areas to realize various functions.

In S440: The electronic device merges the plurality of subareas displaying different contents into one area.

Using this method, the projection condition can be further adjusted, improving the effect of interactive projection according to the information of the interactable object.

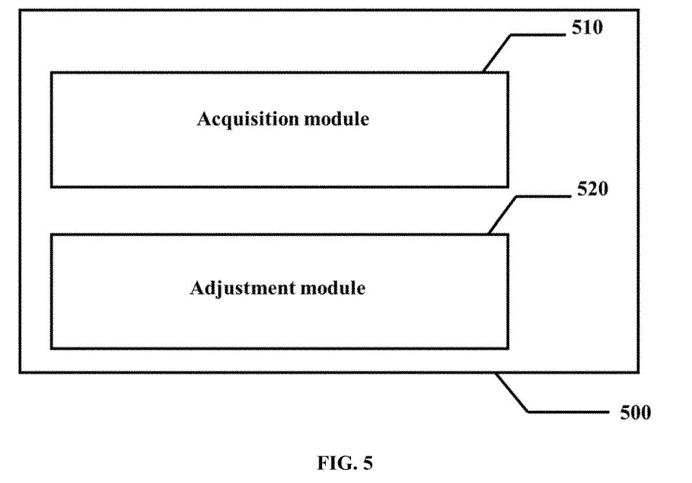

FIG. 5 illustrates a block diagram of a projector 500 according to an embodiment of the present disclosure.

As shown in FIG. 5, the projector 500 may include an acquisition module 510 and an adjustment module 520.

The acquisition module 510, for example, in executing the operation S210 described above with reference to FIG. 2, can acquire ambient parameters of the projection screen that the electronic device projects onto.

The adjustment module 520, for example, in executing the operation S220 described above with reference to FIG. 2, can adjust the size and/or brightness level of the projection image projected on the projection screen by the electronic device based on the ambient parameters.

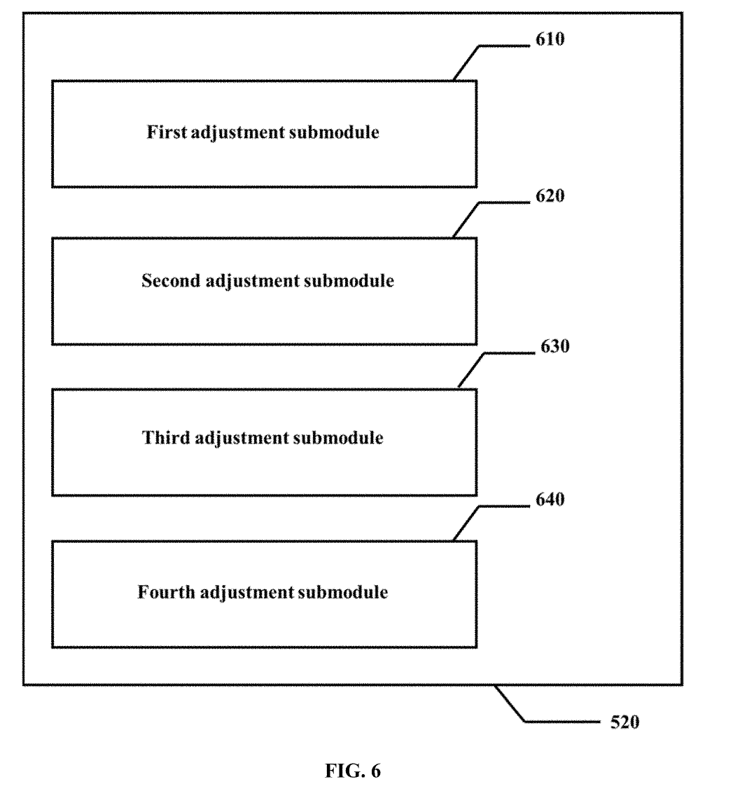

FIG. 6 schematically illustrates a block diagram of an adjustment module 520 according to an embodiment of the present disclosure.

As shown in FIG. 6, the adjustment module 520 may include at least one of a first adjustment submodule 610, a second adjustment submodule 620, or a third adjustment submodule 630.

The first adjustment submodule 610, for example, in executing the operation S310 described above with reference to FIG. 3A, can adjust the distance between the projector of the electronic device and the projection screen, so as to adjust the size and/or brightness level of the projection image projected on the projection screen by the electronic device.

According to embodiments of the present disclosure, the electronic device may further include an operation detector configured to acquire optical information to realize the interactive operation. When the distance between the projector of the electronic device and the projection screen is adjusted, the position of the operation detector can be kept unchanged.

The second adjustment submodule 620, for example, in executing the operation S320 described above with reference to FIG. 3B, can adjust size of the projection image projected on the projection screen by the electronic device based on the size of the projection screen.

The third adjustment submodule 630, for example, in executing the operation S330 described above with reference to FIG. 3C, can adjust the brightness level of the projection image projected on the projection screen by the electronic device based on the positive correlation between the brightness level of the projection image projected on the projection screen by the electronic device and the ambient brightness level.

The fourth adjustment submodule 640, for example, in executing the operation S340 described above with reference to FIG. 3D, can adjust the size and/or brightness level of the projection image projected on the projection screen by the electronic device based on the information of the one or more interactable objects appearing in the projection area of the projection image.

According to embodiments of the present disclosure, the one or more interactable objects may include at least one of the following: an operating device, through which the user may interact with the electronic device, or a device-interactive tool, where the electronic device can perform interactive operation by recognizing an image of the device-interactive tool.

According to embodiments of the present disclosure, the information of the one or more interactable objects may include at least one of quantity of the operating device, or a size and/or quantity of the device-interactive tool.

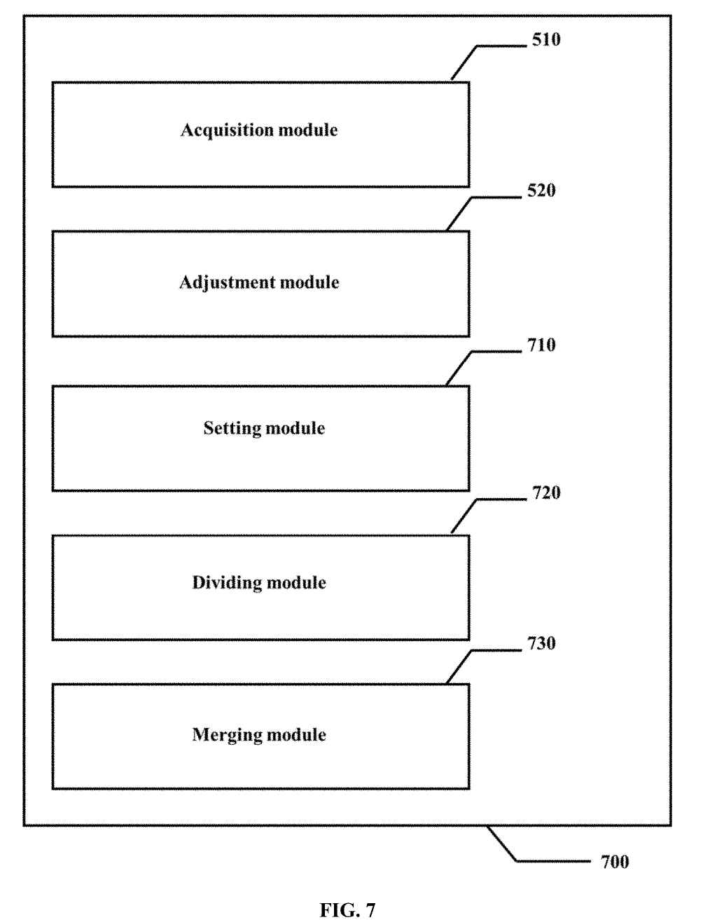

FIG. 7 illustrates a block diagram of a projector 700 according to another embodiment of the present disclosure.

As shown in FIG. 7, a projector 700 may further include at least one of a setting module 710, a dividing module 720, or a merging module 730 on the basis of the projection projector 500 described above.

The setting module 710, for example, in executing the operation S420 described above with reference to FIG. 4, can set a collecting area that does not completely overlap with the projection area of the projection image, where the operation collector may collect optical information to achieve interaction operation in the collecting area.

The dividing module 720, for example, in executing the operation S430 described above with reference to FIG. 4, can divide the projection area of the projection image into a plurality of subareas such that different subareas display different contents.

The merging module 730, for example, in executing the operation S440 described above with reference to FIG. 4, can merge the plurality of subareas displaying different contents into one area.

The projection projector 700 may include a computer-readable memory and one or more processors. The memory can store a plurality of computer-executable instructions, which can be executed by the one or more processors. In some embodiments, the one or more processors may include multiple modules, e.g., the above described modules.

It can be understood that the above modules may be combined in one module, or any one of the modules may be divided into multiple modules. Alternatively, at least some of the functions of one or more of these modules may be combined with at least some of the functions of other modules and implemented in one module. According to an embodiment of the present disclosure, one or more of the above modules may be at least partially implemented as a hardware circuit. For example, the hard ware circuit can be a field programmable gate array (FPGA), a programmable logic array (PLA), a system-on-chip, a system-on-substrate, a system-on-package and an application specific integrated circuit (ASIC), etc. In some other embodiments, one or more of the above modules may be implemented in any other reasonable manner that integrates or encapsulates the circuit using hardware or firmware. In some other embodiments, one or more of the above modules may be implemented in an appropriate combination of three forms of software, hardware, and firmware. Alternatively, one or more of the above modules may be at least partially implemented as a computer program module, and when the program is executed by a computer, the functions of the corresponding modules may be achieved.

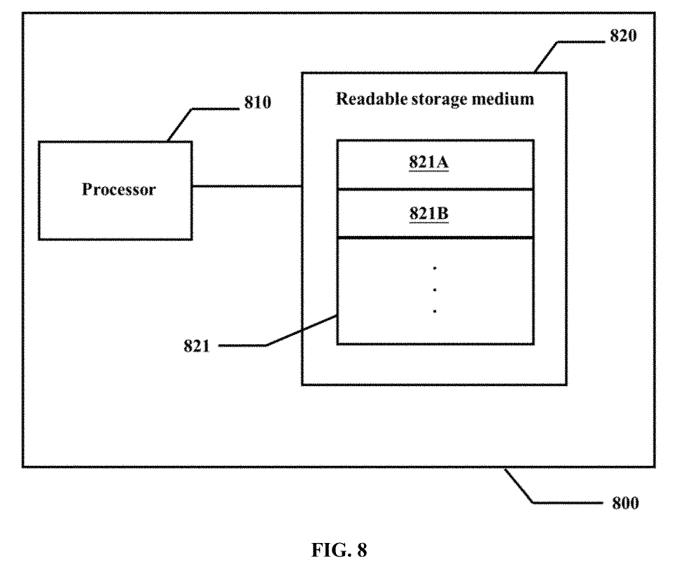

FIG. 8 illustrates a block diagram of an electronic device implementing a method for managing projection of the electronic device according to an embodiment of the present disclosure.

As shown in FIG. 8, an electronic device 800 may include a processor 810 and a computer-readable storage medium 820. The electronic device 800 can perform the method described above with reference to FIG. 2 to FIG. 4 to automatically adjust the size and/or brightness level of the projection image projected on the projection screen by the electronic device based on ambient parameters.

Specifically, the processor 810 may include, for example, a general-purpose microprocessor, an instruction-set processor, a related chip set, and/or a dedicated microprocessor (e.g., an application specific integrated circuits (ASIC)), etc. The processor 810 may also include an onboard memory for caching purposes. The processor 810 may be a single processing unit or a plurality of processing units, configured to execute different operations of the method according to embodiments of the present disclosure described with reference to FIG. 2 to FIG. 4.

The readable storage medium 820 may be, for example, any medium that can contain, store, communicate, propagate, or transport the instructions. For example, the readable medium may include, but is not limited to, an electronic, magnetic, optical, electromagnetic, infrared, or semiconductor system, apparatus, device, or propagation medium. Specific examples of the computer-readable medium include: a magnetic storage device such as a magnetic tape or a hard disk (HDD); an optical storage device such as a compact disk read-only memory (CD-ROM); a memory such as a random-access memory (RAM) or a flash memory; and/or a cable/wireless communication link.

The readable storage medium 820 may include a computer program 821, which may include code/computer-executable instructions that, when executed by the processor 810, cause the processor 810 to execute, for example, the method described above with reference to FIG. 2 to FIG. 4 and any variations thereof.

The computer program 821 may be configured with computer program code including, for example, a computer program module or a program submodule. For example, in an exemplary embodiment, the code in computer program 821 may include one or a plurality of program modules. For example, the computer program 821 may include a module 821A, a module 821B, etc. It should be noted that the division manners and the quantity of modules are not fixed, and those skilled in the art can use suitable program modules or program module combinations according to actual conditions. When these program module combinations are executed by the processor 810, the processor 810 can execute the method described in relation to the functional modules, such as the modules referenced in FIG. 2 to FIG. 4 and any variations thereof.

According to embodiments of the present disclosure, the processor 810 may be able to execute the method described above with reference to FIG. 2 to FIG. 4 and any variations thereof.

According to embodiments of the present disclosure, at least one of the modules described above may be implemented as the computer program module with reference to FIG. 8, which, when executed by the processor 810, may implement the corresponding operations described above.

Those skilled in the art should understand that the features described in embodiments and/or claims of the present disclosure can be combined in various manners, even though such combinations are not explicitly described in the present disclosure. In particular, various combinations of features described in various embodiments and/or claims of the present disclosure may be made without departing from the spirit and teaching of the present disclosure. All these combinations shall fall within the scope of the present disclosure.

Although the present disclosure has been shown and described with reference to specific exemplary embodiments thereof, it will be understood by those skilled in the art that without departing from the spirit and scope of the present disclosure defined by the appended claims and their equivalents, various modifications in form and detail may be made to the present disclosure. Therefore, the scope of the present disclosure should not be limited to the above-described embodiments but should be determined not only by the appended claims but also by the equivalents of the appended claims.

What is claimed is:

1. A method for managing image projection of an electronic device, comprising:
obtaining ambient parameters of a projection screen; and
adjusting a size or a brightness level of a projection image projected on the projection screen by the electronic device, based on the ambient parameters.

2. The method according to claim 1, adjusting at least one of the size or the brightness level of the projection image further comprising:
adjusting a distance between a projector of the electronic device and the projection screen.

3. The method according to claim 1, adjusting at least one of the size or the brightness level of the projection image further comprising:
adjusting the size of projection image on the projection screen based on a size of the projection screen.

4. The method according to claim 2, wherein:
the electronic device further includes an operation detector, the operation detector collecting optical information of an interactive operation; and in response to a distance between a projector of the electronic device and the projection screen being adjusted, a position of the operation detector is kept unchanged.

5. The method according to claim 1, wherein the ambient parameters include an ambient brightness level, the method further comprising:
adjusting the brightness level of the projection image projected on the projection screen, based on a positive correlation between the brightness level of the projection image projected on the projection screen and the ambient brightness level.

6. The method according to claim 1, further comprising:
adjusting the size or the brightness level of a projection image based on information of the one or more interactable objects that appear in the projection area.

7. The method according to claim 6, wherein the one or more interactable objects include at least one of:
an operating device, wherein the user interacts with the electronic device through the operating device; or
a device-interactive tool, wherein the electronic device performs an interactive operation by recognizing an image of the device-interactive tool.

8. The method according to claim 7, wherein the information of the one or more interactable objects include at least one of:
a quantity of the operating device; or
a size or quantity of the device-interactive tool.

9. The method according to claim 6, further comprising:
setting a colleting area that does not completely overlap with the projection area of the projection image, wherein an operation collector collects optical information in the collecting area to implement an interactive operation;
dividing the projection area into a plurality of subareas, different subareas displaying different contents; and
merging the plurality of subareas displaying different contents into one area.

10. An electronic device includes:
a processor; and
a projector coupled to the processor,
wherein the processor is configured to obtain ambient parameters of a projection screen; and adjust a size or a brightness level of a projection image projected on the projection screen by the electronic device, based on the ambient parameters.

11. The electronic device of claim 10, wherein the projector is operable to adjust a distance from the projection screen.

12. The electronic device of claim 10, wherein the projector is operable to adjust the size of projection image on the projection screen, based on a size of the projection screen.

13. The electronic device of claim 11, further comprising an operation detector, wherein the operation detector is operable to:
retrieve optical information of an interactive operation; and
in response to a distance between a projector of the electronic device and the projection screen being adjusted, keep a position of the operation detector unchanged.

14. The electronic device of claim 10, wherein the projector is operable to adjust the brightness level of the projection image projected on the projection screen based on a positive correlation between the brightness level of the projection image projected on the projection screen and an ambient brightness level.

15. The electronic device of claim 10, wherein the projector is operable to adjust the size or the brightness level of a projection image, based on information of the one or more interactable objects that appear in the projection area.

16. The electronic device of claim 15, wherein the one or more interactable objects include one or more of:
an operating device, wherein the user interacts with the electronic device through the operating device; and
a device-interactive tool, wherein the electronic device performs an interactive operation by recognizing an image of the device-interactive tool.

17. The electronic device of claim 16, wherein the information of the one or more interactable objects include one or more of:
a quantity of the operating device; and
a size or quantity of the device-interactive tool.

18. The electronic device of claim 13, wherein the operation detector is operable to:
retrieve optical information in a collecting area that does not completely overlap with a projection area of the projection image, to implement an interactive operation;
divide the projection area into a plurality of subareas, different subareas displaying different contents; and
merge the plurality of subareas displaying different contents into one area.

19. A projector, comprising:
an acquisition module that is configured to obtain ambient parameters of a projection screen; and
an adjustment module that is configured to adjust a size or a brightness level of a projection image projected on the projection screen based on the ambient parameters.
